(19) United States
(12) Patent Application Publication
(10) Pub. No.: US 2007/0293950 A1
(43) Pub. Date: Dec. 20, 2007

(54) Web Content Extraction

(75) Inventors: Todd Haugen, Clyde Hill, WA (US); Suzan M. Andrew, Redmond, WA (US); John E. Knapp, Seattle, WA (US); Melinda E. Nascimbeni, Seattle, WA (US); Craig Henry, Woodinville, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/424,214

(22) Filed: Jun. 14, 2006

(51) Int. Cl. G05B 15/00

(52) U.S. Cl. 700/1

(57) ABSTRACT

A system for extracting and saving web content for future reference, the system comprising an identifying means for allowing a user to identify the web content to be extracted and saved, a manipulation means for allowing the user to manipulate the identified web content such that it is extracted and saved, an extracting means for extracting operable elements of the identified web content, and a saving means for saving the extracted operable elements of the identified web content. The system further comprising a rendering means for rendering the saved operable elements of the identified web content on a local device, the rendering means not requiring access to the web content.

### TECHNICAL FIELD

This description relates generally to saving web content and more specifically to identifying, selecting, extracting and saving of the operable elements of web content such that they can be rendered to recreate the web content on a local device without access to the original web content and the web site from which it came.

### BACKGROUND

The Internet, or world-wide web (“web”), has become very popular and powerful as a source of information, communication and transaction. But the web is also very dynamic—web content, such as news, articles, graphics, videos, or any other information, data, or functionality, can change very rapidly. While web users may save links to interesting information, the information at those links may change, or may disappear entirely, over time. For example, a news story of interest may be available on the web today and be moved or removed several days later. Should a user save a link to such a news story, that link may fail to provide access to the news story after it has been moved or removed.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present invention provides technology for identifying and selecting web content, and extracting and saving it on a local device such that it can later be rendered or recreated in an essentially identical, fully-functioning form on the local device without requiring a network or Internet connection, or access to the original web site that contained the web content. A user is then able, at a later time, to locally view and access the selected web content without regard to what may have occurred with respect the original web content.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is an image of example web content displayed in a browser.

FIG. 2 is the image of example web content with the addition of an example dashed rectangle drawn to identify and select the web content section titled “Weather News”.

FIG. 3 is the image of example web content including the example selection rectangle, and an additional example icon usable to drag-and-drop the selection on to a drop site.

FIG. 4 is a block diagram showing an example method for extracting and saving web content for future reference.

FIG. 5 is a block diagram showing an example client operating in an example computing environment, the client usable to extract and store selected web content for future use.

FIG. 6 is a block diagram showing an example computing environment in which the technologies, systems and methods described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a computing and networking system, the system described is provided as an example and not a limitation. As those skilled in the art will appreciate, the present examples are suitable for application in a variety of different types of computing systems.

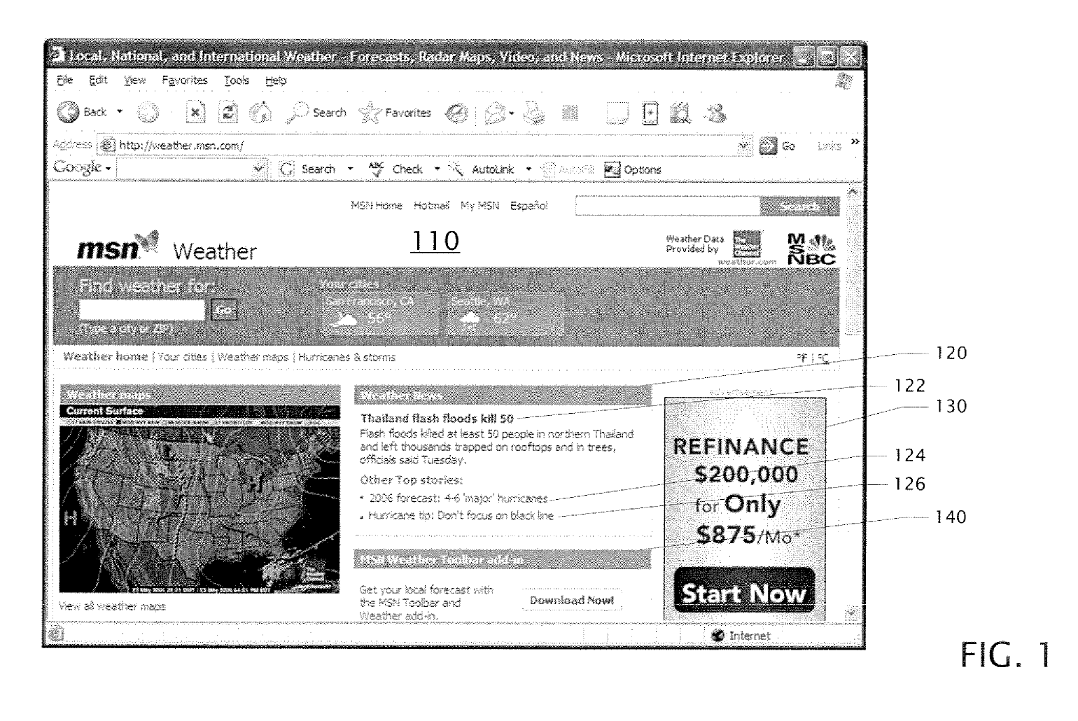

FIG. 1 is an image of example web content 110 displayed in a browser. Web content 110 may be part of a larger web page which may not be entirely visible in FIG. 1. Web content 110 includes several example sections, including “Weather News” section 120, advertisement 130, and “MSN Weather Toolbar add-in” section 140. Example section 120 includes a link 122 to a main story and also links 124 and 126 to other stories. Many other examples of web content are possible including links to other web pages, graphics, various web controls and the like, text, images, video segments, audio segments, etc. Web content is typically accessed from one or more web sites or servers that contain the web content.

Web content, as understood by those skilled in the art, is typically defined and implemented using various types of code such as hypertext markup language (“HTML”) and the like, text, formatting codes, various types of controls, style sheets, files, and the like. Such code is typically downloaded from a web site to a client device or local device, the code being interpreted and/or executed to render and display the web content. Portions of such code, referred to herein as “operable elements”, may define and provide for the functionality of various sections or portions of a web page, such as sections 120, 130 and 140 and the like.

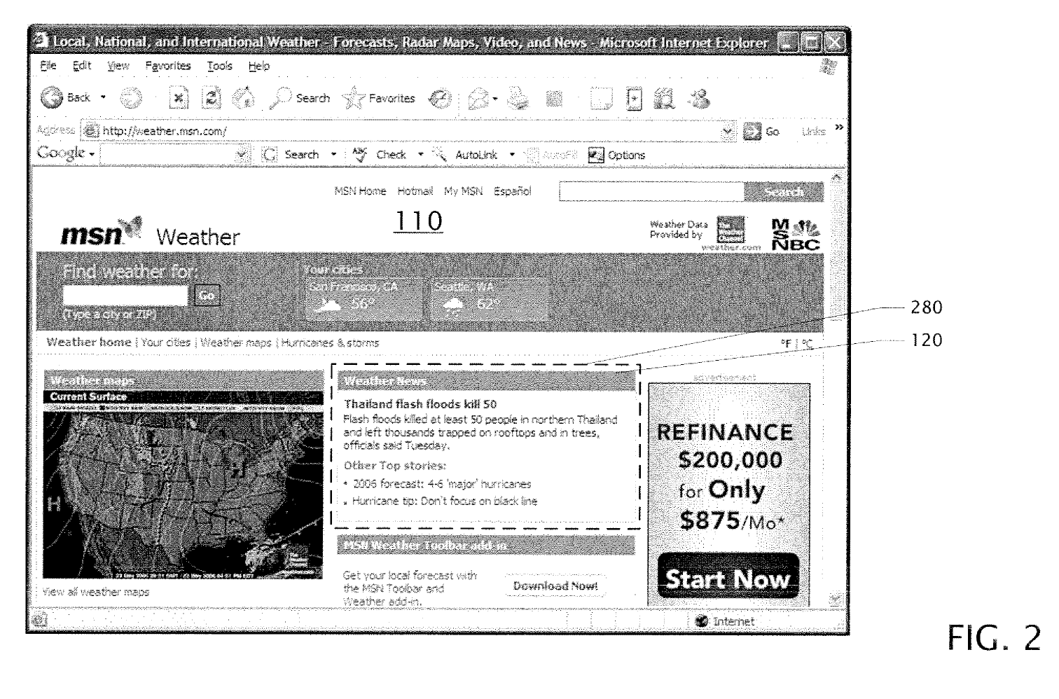

FIG. 2 is the image of example web content 110 with the addition of an example dashed rectangle 280 drawn to identify and select the web content section 120 titled “Weather News”. Other graphical techniques may also be used to select or identify a section of web content, a portion of a web page, or an entire web page. By selecting a portion of web content, the user identifies the portion to be extracted and stored. Various software tools and/or graphical mechanisms known to those skilled in the art may be provided for a user to identify and select web content. Such identification and selection tools may be used to select any portion or portions of web content, including one or more portions of a web page or an entire web page.

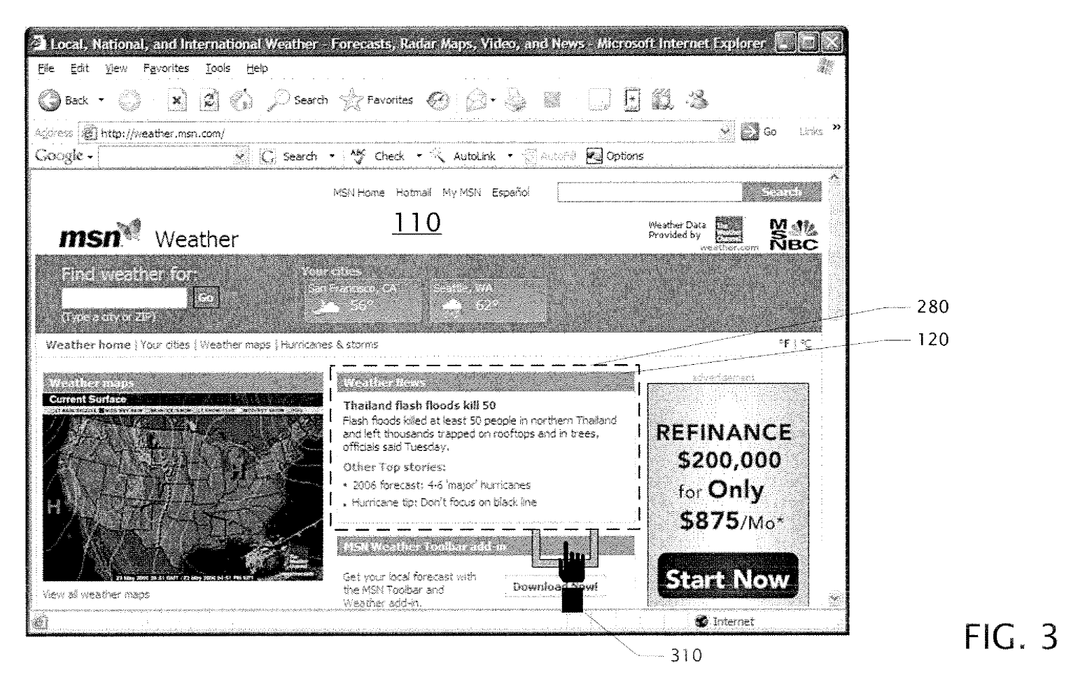

FIG. 3 is the image of example web content 110 including the example selection rectangle 280, and an additional example icon 310 usable to drag-and-drop the selection 120 on to a drop site. Such an icon 310 is usable by a user to manipulate or “move” the selection to a drop site, causing the selection to be extracted and stored for future reference. Other mechanisms may alternatively be used to manipulate web content, including other drag-and-drop techniques, icons, graphics and the like, menu selections, key strokes, etc.

In one example a drop site is a graphically defined location acting as the “drop destination” for a typical drag-and-drop action. Such a drop site may be graphically represented using any recognizable construct. By dragging-and-dropping a web content selection onto a drop site, a user causes the selection to be extracted and saved for future reference. Alternatively, menu selections, key strokes, or the like may be used to identify a selection to be extracted and saved for future reference.

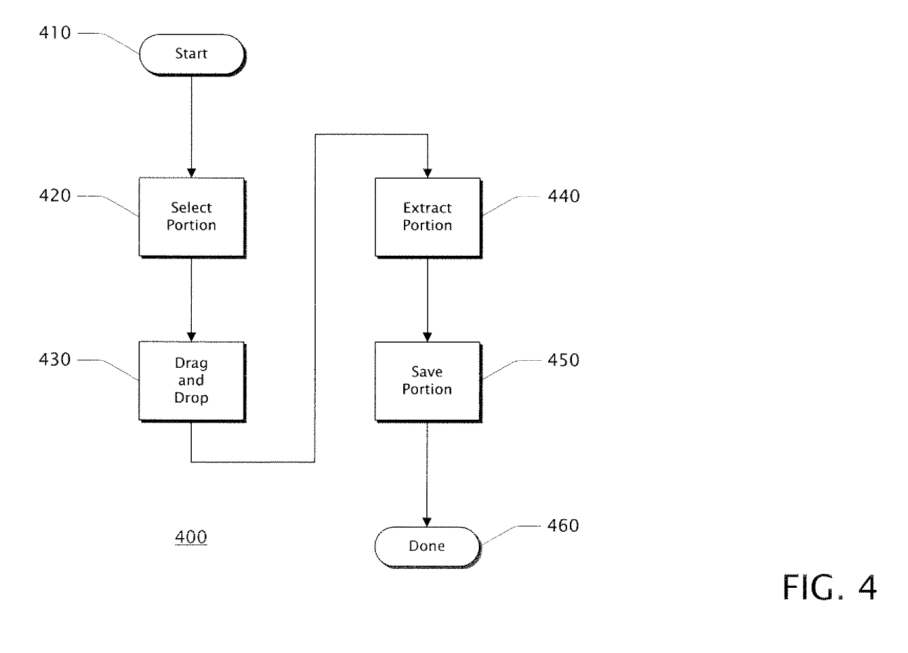

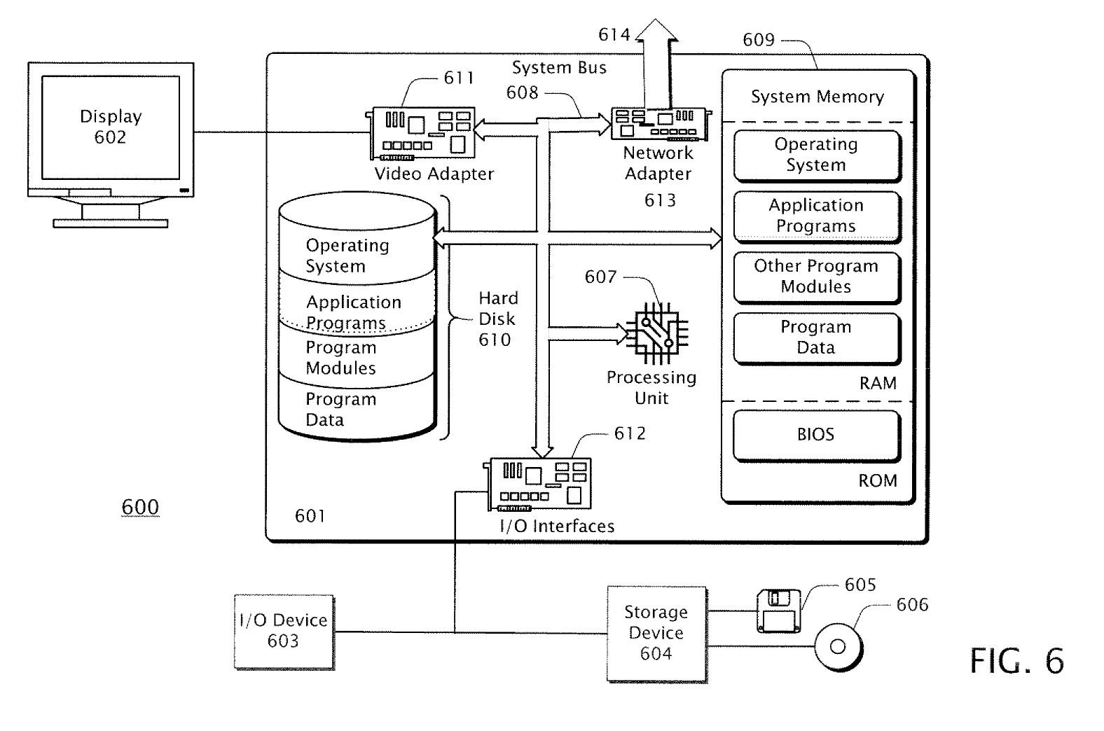

FIG. 4 is a block diagram showing an example method 400 for extracting and saving web content for future reference. Such extracted and saved web content may be later accessed and rendered such that it appears and functions as it did originally, but without requiring network connectivity or access to the web content's original web site. In one example, such extraction and saving functionality is provided by client software operating on a local device. Alternatively, such functionality may be provided via any number of software systems, architectures or applications. In one example, the local device is a computing environment such as described in connection with FIG. 6.

Example method 400 starts 410 with a user identifying and selecting a portion 420 of web content. Such a portion may include any part or parts of a web page or an entire web page. In one example, the user may drag-and-drop 430 the selected portion(s) to a drop site, thus beginning an extraction and saving operation. In alternative examples, the user may identify and select the portion(s) to be extracted and saved in a variety of ways not including drag-and-drop or a drop site, such as, but not limited to, the use of menus, keystrokes, buttons, controls, and/or programmatic means or the like.

Next, the identified and selected portion(s) is extracted 440 from the web content. Extraction is typically performed by the client software and includes identifying and extracting all operable elements of the web content required for the selected portion(s) to fully operate on the local device without network access to the original web content's web site. Full operation includes the operation of any selected links, text, formatting, graphics, controls and the like, any advertisements, banners, pop-ups and the like, as on the original web content. Extraction includes extracting all portions of web content code required for full operation of the selected portion(s), such code referred to herein as operable elements.

Further included with the extracted code are the operable elements for any web pages or content linked to by the selected portion, and for any pages those pages may link to—the chain of links. This extraction of code for the chain of links is carried on to a pre-defined depth. For example, the client may extract web content for the selected portion and for the web content of any links included in the selected portion, but no further web content—a depth of selection itself and one level down. Such a pre-defined depth may be configurable by the user and/or may be pre-set by the client. Extraction of links and associated operable elements may also be limited or excluded based on other properties, factors and/or considerations including, but not limited to, address, content, size of content, etc.

Next, the extracted operable elements of the selected content are saved 450 in a local store such that they can later be accessed. In one example the user provides a name via a naming mechanism to identify the saved content. Such a naming mechanism may be provided via a user interface or some other conventional method or the like. The user may also group or organize the content with other previously extracted and saved content. Once the save operation is complete the example method 400 is done 460. In general, all operable elements required for the full operation of the selected portion(s) are extracted from the web content and saved locally such that the selected portion(s) can later be rendered, displayed and made fully-functional on the client, within the depth limits described herein, without requiring a network connection or access to the selected web content's original web site.

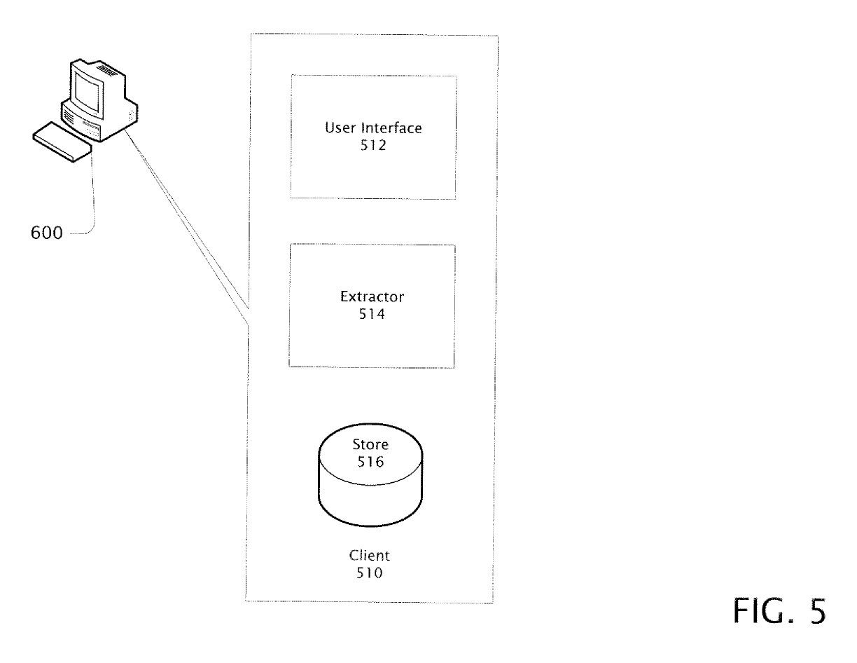

FIG. 5 is a block diagram showing an example client 510 operating in an example computing environment 600, the client 510 usable to extract and store selected web content for future use. Example client 510 may be implemented as part of an operating system, as a software application, as a web browser or extension of a web browser, or as some other type of computer program or the like. In one example, client 510 includes a user interface 512 to enable users to identify and select web content and begin the extraction process. The extraction process is carried out by extractor 514 and the extracted web content is saved in local store 516. Once selected web content has been extracted and saved, it can later be retrieved from the local store 516 and rendered or recreated in a fully-functional fashion without requiring network connectivity or access to the web content's original web site.

FIG. 6 is a block diagram showing an example computing environment 600 in which the technologies, systems and methods described herein may be implemented. A suitable computing environment may be implemented with numerous general purpose or special purpose systems. Examples of well known systems may include, but are not limited to, personal computers (“PC”), hand-held or laptop devices, microprocessor-based systems, multiprocessor systems, servers, workstations, consumer electronic devices, set-top boxes, and the like.

Computing environment 600 typically includes a general-purpose computing system in the form of a computing device 601 coupled to various peripheral devices 602, 603, 604 and the like. System 600 may couple to various input devices 603, including keyboards and pointing devices, such as a mouse or trackball, via one or more I/O interfaces 612. The components of computing device 601 may include one or more processors (including central processing units (“CPU”), graphics processing units (“GPU”), microprocessors (“uP”), and the like) 607, system memory 609, and a system bus 608 that typically couples the various components. Processor 607 typically processes or executes various computer-executable instructions to control the operation of computing device 601 and to communicate with other electronic and/or computing devices, systems or environment (not shown) via various communications connections such as a network connection 614 or the like. System bus 608 represents any number of several types of bus structures, including a memory bus or memory controller, a peripheral bus, a serial bus, an accelerated graphics port, a processor or local bus using any of a variety of bus architectures, and the like.

System memory 609 may include computer readable media in the form of volatile memory, such as random access memory (“RAM”), and/or non-volatile memory, such as read only memory (“ROM”) or flash memory (“FLASH”). A basic input/output system (“BIOS”) may be stored in non-volatile or the like. System memory 609 typically stores data, computer-executable instructions and/or program modules comprising computer-executable instructions that are immediately accessible to and/or presently operated on by one or more of the processors 607.

Mass storage devices 604 and 610 may be coupled to computing device 601 or incorporated into computing device 601 via coupling to the system bus. Such mass storage devices 604 and 610 may include a magnetic disk drive which reads from and/or writes to a removable, non-volatile magnetic disk (e.g., a “floppy disk”) 605, and/or an optical disk drive that reads from and/or writes to a non-volatile optical disk such as a CD ROM, DVD ROM 606. Alternatively, a mass storage device, such as hard disk 610, may include non-removable storage medium. Other mass storage devices may include memory cards, memory sticks, tape storage devices, and the like.

Any number of computer programs, files, data structures, and the like may be stored on the hard disk 610, other storage devices 604, 605, 606 and system memory 609 (typically limited by available space) including, by way of example, operating systems, application programs, data files, directory structures, and computer-executable instructions.

Output devices, such as display device 602, may be coupled to the computing device 601 via an interface, such as a video adapter 611. Other types of output devices may include printers, audio outputs, tactile devices or other sensory output mechanisms, or the like. Output devices may enable computing device 601 to interact with human operators or other machines or systems. A user may interface with computing environment 600 via any number of different input devices 603 such as a keyboard, mouse, joystick, game pad, data port, and the like. These and other input devices may be coupled to processor 607 via input/output interfaces 612 which may be coupled to system bus 608, and may be coupled by other interfaces and bus structures, such as a parallel port, game port, universal serial bus (“USB”), fire wire, infrared port, and the like.

Computing device 601 may operate in a networked environment via communications connections to one or more remote computing devices through one or more local area networks (“LAN”), wide area networks (“WAN”), storage area networks (“SAN”), the Internet, radio links, optical links and the like. Computing device 601 may be coupled to a network via network adapter 613 or the like, or, alternatively, via a modem, digital subscriber line (“DSL”) link, integrated services digital network (“ISDN”) link, Internet link, wireless link, or the like.

Communications connection 614, such as a network connection, typically provides a coupling to communications media, such as a network. Communications media typically provide computer-readable and computer-executable instructions, data structures, files, program modules and other data using a modulated data signal, such as a carrier wave or other transport mechanism. The term “modulated data signal” typically means a signal that has one or more of its characteristics set or changed in such a manner as to encode information in the signal. By way of example, and not limitation, communications media may include wired media, such as a wired network or direct-wired connection or the like, and wireless media, such as acoustic, radio frequency, infrared, or other wireless communications mechanisms.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or distributively process the software by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” typically refers to executable instructions, code or data maintained in an electronic device such as a ROM. The term “software” generally refers to executable instructions, code, data, applications, programs, or the like maintained in or on any form of computer-readable media. The term “computer-readable media” typically refers to system memory, storage devices and their associated media, and the like.

In view of the many possible embodiments to which the principles of the present invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

1. A system for extracting and saving web content for future reference, the system comprising:
an identifying means for allowing a user to identify the web content to be extracted and saved;
a manipulation means for allowing the user to manipulate the identified web content such that it is extracted and saved;
an extracting means for extracting operable elements of the identified web content; and
a saving means for saving the extracted operable elements of the identified web content.

2. The system of claim 1 further comprising a rendering means for rendering the saved operable elements of the identified web content on a local device, the rendering means not requiring access to the web content.

3. The system of claim 2 wherein the rendering means comprises a means for displaying the rendered operable elements.

4. The system of claim 1 further comprising a naming means for allowing the user to provide a name for the saved operable elements of the identified web content, the name usable to retrieve the saved operable elements of the identified web content.

5. The system of claim 1 wherein the manipulation means provides for dragging and dropping the identified web content onto a drop site.

6. The system of claim 2 wherein the rendered operable elements of the identified web content are operable on the local device without access to the web content.

7. The system of claim 1 wherein the saved operable elements include text of the identified web content.

8. The system of claim 1 wherein the saved operable elements include graphics of the identified web content.

9. The system of claim 1 wherein the saved operable elements include code of the identified web content.

10. The system of claim 1 wherein the identified web content is an entire web page.

11. The system of claim 1 wherein the identified web content is a portion of a web page.

12. A method for extracting and saving web content for future reference, the method comprising:
on a local device, selecting a portion of the web content to establish a selected portion;
extracting operable elements from the portion sufficient to recreate the portion; and
saving the operable elements such that the operable elements can be rendered on the local device without access to the web content.

13. The method of claim 12 wherein the rendering includes recreating the web content from the saved operable elements.

14. The method of claim 12 further comprising providing a name for the selected portion, the name usable for the saving and to retrieve and render the saved operable elements.

15. The method of claim 12 wherein the operable elements include text of the selected portion.

16. The method of claim 12 wherein the operable elements includes graphics of the selected portion.

17. The method of claim 12 wherein the operable elements portion includes code of the selected portion.

18. The method of claim 12 embodied as computer-executable instructions on a computer-readable medium.

19. A system for extracting and saving web content for future reference, the system comprising:
a client;
a network connection coupling the client to a web site including a web content;
a selection means for selecting a portion of the web content; and
an extraction means for extracting operable elements of the portion; the operable elements being sufficient to recreate the portion without requiring the network connection.

20. The system of claim 19 further comprising a naming means usable to enable a user to provide a name for the portion, the name usable to save and retrieve the operable elements.
